(19) United States
(12) Patent Application Publication
(10) Pub. No.: US 2014/0347244 A1
(43) Pub. Date: Nov. 27, 2014

(54) ELECTRONIC DEVICE FOR ELECTROMAGNETIC EXPANSION AND CONCENTRATION

(71) Applicant: STMicroelectronics S.r.l., Agrate Brianza (IT)

(72) Inventors: Alberto PAGANI, NOVA MILANESE (IT); Alessandro FINOCCHIARO, Catania (IT); Giovanni GIRLANDO, Catania (IT)

(73) Assignee: STMicroelectronics S.r.l., Agrate Brianza (IT)

(21) Appl. No.: 14/283,326

(22) Filed: May 21, 2014

(30) Foreign Application Priority Data
May 21, 2013 (IT) MI2013A000818

(51) Int. Cl. H01Q 21/00; H02J 5/00; H01Q 7/00

(52) U.S. Cl. CPC H01Q 21/00; H01Q 7/00; H02J 5/005
USPC 343/867; 343/893

(57) ABSTRACT

An electronic device for electromagnetic expansion and concentration is described, including: —a module to be monitored including a first antenna and an integrated control circuitry, the first antenna being electrically coupled to the integrated control circuitry; an electromagnetic expansion and concentration module comprising a second antenna configured to communicate with a remote antenna of an external data collection and control device, relative to the electromagnetic expansion and concentration module, by an electromagnetic coupling, said electromagnetic expansion and concentration module comprising a third antenna electrically coupled to said second antenna, said third antenna being configured to communicate with said first antenna of the module to be monitored by a near-field magnetic coupling. The second antenna is configured to communicate with said remote antenna, relative to the electromagnetic expansion and concentration module by a far-field electromagnetic coupling. The electromagnetic expansion and concentration module further comprises a fourth antenna electrically coupled between said second antenna and said third antenna, said fourth antenna being configured to communicate with a further remote antenna of a further external data collection and control device, relative to the electromagnetic expansion and concentration module by a near-field magnetic coupling.

### PRIORITY CLAIM

The instant application claims priority to Italian Patent Application No. MI2013A000818, filed 21 May 2013, which application is incorporated herein by reference in its entirety.

### TECHNICAL FIELD

An embodiment generally relates to electronic systems for data reading/writing monitoring, in particular to an electronic device for expansion and concentration that can be used within an electronic monitoring system.

### SUMMARY

A typical electromagnetic expansion and concentration electronic device is composed of an electromagnetic expansion and concentration module and a module to be monitored (for example, a TAG RFID).

The module to be monitored is composed of an antenna and integrated electronic circuitry.

The electromagnetic expansion and concentration module typically includes a first antenna configured to communicate by a near-field magnetic coupling with the antenna of the module to be monitored, and a second antenna configured to communicate by an electromagnetic coupling with a remote antenna of an external data collection and control device relative to the electronic device for electromagnetic expansion and concentration.

The electromagnetic expansion and concentration module allows, by virtue of its structure, both a transmission/reception of telecommunications signals (for example, the transmission of data provided by the module to be monitored and the reception of operative commands for the module to be monitored provided by the external data collection and control device), and a supply energy exchange (for example, reception of radiofrequency waves for a power supply).

The electromagnetic expansion and concentration module performs a function of electromagnetic expansion and concentration, i.e., it is configured to concentrate an external electromagnetic field, and the relative energy, on the antenna of the module to be monitored and, in a completely similar manner, to expand an electromagnetic field emitted by the antenna of the module to be monitored, and the relative energy, towards the remote antenna of the external data collection and control device.

The electronic device for electromagnetic expansion and concentration described above has the drawback of not being sufficiently stable, with respect to the needs required these days, as regards the adaptation of the impedance of the second antenna of the electromagnetic expansion and concentration module to the impedance of the integrated electronic circuitry of the module to be monitored, which drawback is mainly due to the operational difficulty in mutually aligning the electromagnetic expansion and concentration module and the module to be monitored, which can occur during the step of assembling the device. In addition to this, there is a variability in the micro-electronic manufacturing process, which may involve variations of the impedance of the integrated electronic circuitry of the module to be monitored.

An embodiment is an electronic device for electromagnetic expansion and concentration that is more reliable compared to that described above, in particular, that is more stable and also adaptable.

### BRIEF DESCRIPTION OF THE DRAWINGS

Further characteristics and advantages of the device according to an embodiment will be apparent from the description set forth below of implementation examples, given by way of illustrative, non-limiting example, with reference to the appended Figures, in which:

FIG. 1 illustrates by a block diagram an electronic monitoring system including an electronic device for electromagnetic expansion and concentration according to an embodiment.

FIG. 2 illustrates, in a plane view, an electronic device for electromagnetic expansion and concentration according to an embodiment.

FIG. 3 illustrates, from a circuital viewpoint, the electronic device for electromagnetic expansion and concentration of FIG. 2 according to an embodiment.

FIG. 4 illustrates, in a plane view, an electronic device for electromagnetic expansion and concentration according to a further embodiment.

FIG. 5 illustrates, in a plane view, an element of the electronic device for expansion and concentration of FIG. 4, according to an embodiment.

FIG. 6 illustrates, from a circuital viewpoint, the electronic device for electromagnetic expansion and concentration of FIG. 4, according to an embodiment.

FIG. 7 illustrates, in a plane view, an electronic device for electromagnetic expansion and concentration according to a further embodiment.

FIG. 8 illustrates, from a circuital viewpoint, the electronic device for electromagnetic expansion and concentration of FIG. 7, according to an embodiment.

FIGS. 9-12 illustrate, in a plane view, an electronic device for electromagnetic expansion and concentration according to further embodiments.

FIG. 13 illustrates an electronic device for electromagnetic expansion and concentration according to a further embodiment.

FIGS. 14a-14f illustrate, in a plane view, an electronic device for electromagnetic expansion and concentration according to further embodiments.

FIGS. 15a-15f illustrate, in a plane view, an electronic device for electromagnetic expansion and concentration according to further embodiments.

### DETAILED DESCRIPTION

With reference to the above-mentioned Figures, an electronic monitoring system, referred to herein below also simply as a system, is indicated with 100, according to an embodiment on the whole.

It is pointed out that in the Figures, elements that are equal or similar, are indicated with the same numeral references.

As it will be also indicated below, the monitoring system 100 may find application in a number of fields, i.e., wherever a local acquisition of information to be transmitted remotely to corresponding data collection and control devices is necessary, or, in combination or alternatively, locally sending monitoring control signals from a remote location is required.

For these reasons, the applications of the monitoring system may range in a number of fields, from radiofrequency identification devices, in which a TAG reading in RFID (Radio Frequency Identification) technology is performed, to the monitoring of parameters within a solid structure, for example in concrete, in which both a reading and a control of integrated monitoring devices (for example, sensors) are performed, which are buried within the solid structure.

The system 100 includes an electronic device for electromagnetic expansion and concentration 1.

The electronic device for electromagnetic expansion and concentration 1 includes a module to be monitored 2 including a first antenna A1 and an integrated control circuitry 3. The first antenna A1 is electrically coupled to the integrated control circuitry 3 of the module to be monitored 2.

In an embodiment, the first antenna A1 and the integrated control circuitry 3 are integrated on a single chip in a semiconductor material (herein below also referred to simply as a chip), typically silicon.

In accordance with a further embodiment, the first antenna A1 is external to the integrated control circuitry 3, obtained on a chip in a semiconductor material.

In particular, the first antenna A1 and the chip corresponding to the integrated control circuitry 3 can be electrically coupled to one another on a rigid support or on a flexible support, in a so-called SiP (System in Package) encapsulated system. In this case, the first antenna A1 can be obtained in the substrate of the package or in the package upper part, as a discrete object, i.e., near to the package surface, or still wrapped in a magnetic material before inserting it into the package.

Alternatively, the first antenna A1 can be integrated together with the integrated control circuitry 3 on a small plate in a semiconductor material or chip in a so-called integrated system or SoC (System on Chip).

The first antenna A1 is configured to exchange data with the exterior, relative to the module to be monitored 3, by a near-field magnetic coupling.

In particular, the first antenna A1 is configured, for example, for transmitting to the outside in wireless mode data provided by the integrated control circuitry 3.

Furthermore, in accordance with a further embodiment, the first antenna A1 is configured to receive from an external source (outside), relative to the module to be monitored 3, operative control commands.

In addition, in accordance with a further embodiment, the first antenna A1 is configured to receive from the outside, relative to the module to be monitored 2, radiofrequency waves used for a remote feeding (or “remote power feeding”) of the module to be monitored 2, i.e., of the same first antenna 1 and the electronic control circuitry 3.

The integrated control circuitry 3 is configured to communicate data to the outside, relative to the module to be monitored 2, through the first antenna A1 by a near-field magnetic coupling.

In more detail, from an operational viewpoint, the integrated control circuitry 3 may include auxiliary or functional blocks, such as, for example, a power-supply circuit, a driving circuit, and a control circuit (not shown in the Figures).

In addition, the integrated control circuitry 3 may be, from a circuital viewpoint, of a passive type, of an active type, or of a semi-passive or semi-active type.

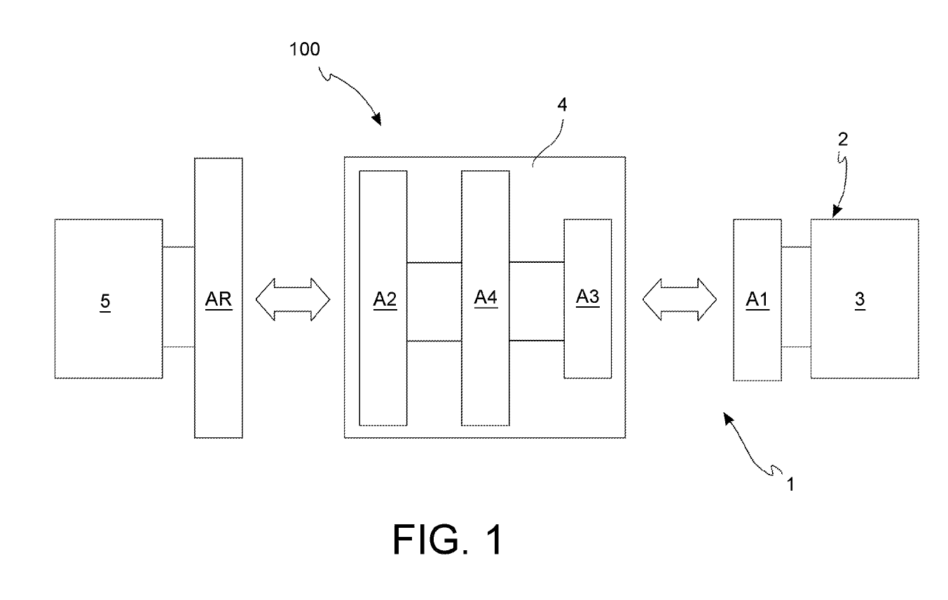

Referring back to FIG. 1, the electromagnetic expansion and concentration electronic device 1 further includes an electromagnetic expansion and concentration module 4.

The electromagnetic expansion and concentration module 4 includes a second antenna A2 configured to communicate with a remote antenna AR electrically coupled to an external data collection and control device 5, relative to the electromagnetic expansion and concentration module 4, by an electromagnetic coupling (in near or far field).

Furthermore, the electromagnetic expansion and concentration module 4 includes a third antenna A3 operatively coupled to the second antenna A2.

The third antenna A3 is configured to communicate with the first antenna A1 of the module to be monitored by a near-field magnetic coupling.

The electromagnetic expansion and concentration module 4 is configured to allow, by virtue of its structure, both a transmission/reception of telecommunications signals (for example, the transmission of data provided by the module to be monitored 2 and the reception of operative commands for the module to be monitored 2 provided by the external data collection and control device 5), and a supply energy exchange (for example, reception of radiofrequency waves for power supply).

Furthermore, the electromagnetic expansion and concentration module 4 is configured to perform a function of electromagnetic expansion and concentration, i.e., it is configured to concentrate an external electromagnetic field, and the relative energy, on the first antenna A1 of the module to be monitored and, in a completely similar manner, to expand an electromagnetic field emitted by the first antenna A1 of the module to be monitored, and the relative energy, towards the remote antenna AR of the external data collection and control device 5.

It has been noticed that by inserting downstream of the second antenna A2, as a load, a matching network, interposed between the second antenna A2 and the third antenna A3, the electronic device for electromagnetic expansion and concentration 1 considerably increases its operative stability independently from the exact position of the module to be monitored 2 relative to it.

In more detail, it has been noticed the possibility to configure the second antenna A2 in such a manner as to allow the communication of data with the remote antenna AR (of the external data collection and control device 5) by a far-field electromagnetic coupling and to electrically couple the second antenna A2 to the third antenna A3 through a matching network, such as a load, and more precisely a fourth antenna A4 electrically arranged between the second antenna A2 and the third antenna A3, by configuring the fourth antenna A4 in such a manner as to allow the communication of data with a further remote antenna (not shown in the Figures) by a near-field magnetic coupling.

Therefore, the introduction of the fourth antenna A4 (matching network) allows improving the stability of the electronic device for electromagnetic expansion and concentration 1, since the adaptation of the second antenna A2 to the integrated control circuitry 3 is improved, while configuring the second antenna A2 for the far-field electromagnetic coupling and the fourth antenna A4 for the near-field magnetic coupling allows the electromagnetic expansion and concentration electronic device 1 to also be more adaptable.

In fact, such device can be arbitrarily used both in applications in which the communication towards a remote antenna in a far-field electromagnetic coupling (in which also a better adaptation with the integrated control circuitry of the antenna configured to communicate by a far-field electromagnetic coupling occurs) occurs, and in applications in which the communication towards another remote antenna in a near-field magnetic coupling is possible.

In other terms, the second antenna A2 is configured to communicate with the remote antenna AR, relative to the electromagnetic expansion/concentration module 4, by a far-field electromagnetic coupling.

Furthermore, the electromagnetic expansion and concentration module 4 includes a fourth antenna A4 electrically coupled between the second antenna A2 and the third antenna A3 of the electromagnetic expansion and concentration module 4. The fourth antenna A4 is configured to communicate with a further remote antenna of a further external data collection and control device (neither of which are shown in the Figures), relative to the electromagnetic expansion and concentration module 4, by a near-field magnetic coupling.

Generally, referring back to the electromagnetic expansion and concentration module 4, it is pointed out that the latter, in accordance with different embodiments, can be bidimensional, i.e., obtained on a planar support, or tridimensional, as it will be described herein below.

Furthermore, from a circuital viewpoint, the electromagnetic expansion and concentration module 4 is of a passive type, optionally configured to operate at different operative frequencies (for example, a first operative frequency for the far-field electromagnetic coupling, and a second operative frequency, different from the first operative frequency, for the near-field magnetic coupling).

With reference to FIG. 1, it is pointed out that the first antenna A1 of the module to be monitored 2 is galvanically isolated from the third antenna A3 of the electromagnetic expansion and concentration module 4.

In fact, no physical connection is used to electrically couple the first antenna A1 and the third antenna A3 together, hence there is not physical connection used to electrically couple the module to be monitored 2 and the electromagnetic expansion and concentration module 4. In this manner, only the magnetic coupling between the first antenna A1 and the third antenna A3 is available.

As it will be restated also in the description of other embodiments, this allows, during the assembling of the electromagnetic expansion and concentration electronic device 1, positioning the module to be monitored 2 (in particular, the integrated control circuitry 3) at the third antenna A3 of the electromagnetic expansion and concentration module 4, also without a perfect alignment between the components. This allows a simpler assembling, with implementation times and costs that are undoubtedly reduced compared to those device that need an accurate alignment between the components in the case that it is necessary to electrically couple the module to be monitored and the third antenna of the electromagnetic expansion and concentration module.

Furthermore, the fact of not having physical (electric) connections between the module to be monitored 2 and the electromagnetic expansion and concentration module 4 allows avoiding the wearing and corrosion problems that are typical of such connections (for example, due to the presence of humidity, jumps in temperature, and so on) causing a malfunctioning of the electromagnetic expansion and concentration electronic device.

In addition, as it will also be described in herein below with reference to a specific application, the electronic device for electromagnetic expansion and concentration according to an embodiment also the advantage of the fact that, in the absence of a physical connection between the module to be monitored 2 and the electromagnetic expansion and concentration module 4, the latter is not mechanically constrained to the other one. In other terms, the electromagnetic expansion and concentration module 4 is mobile relative to the module to be monitored 2.

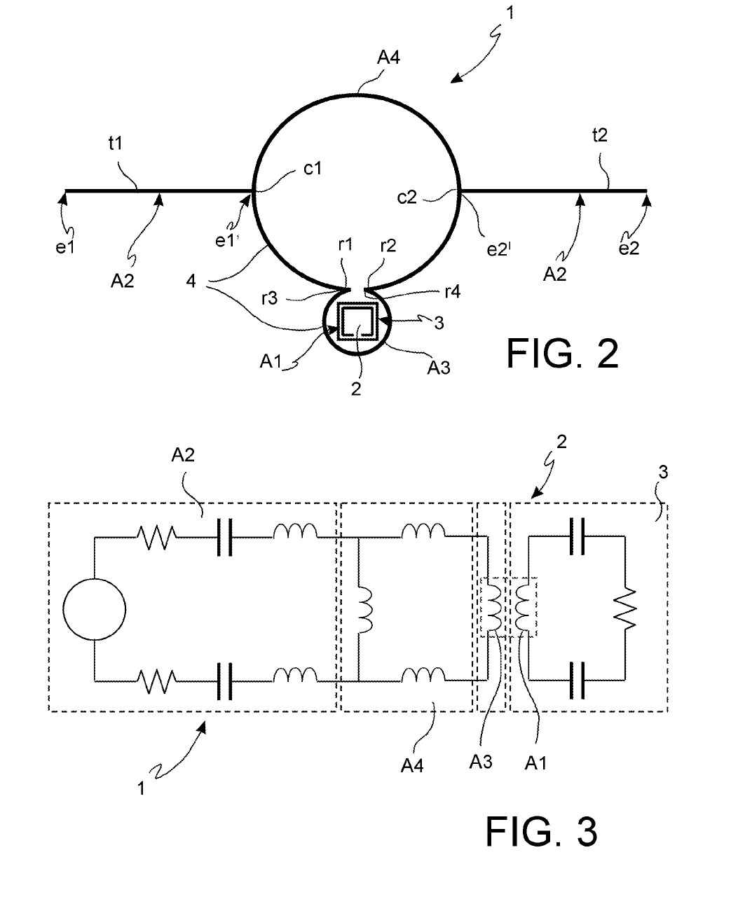

Referring now to FIG. 2, an electronic device for electromagnetic expansion and concentration 1 according to an embodiment is now described in a plane view.

The module to be monitored 2 is a chip in a semiconductor material in which both the electronic control circuitry 3 and the first antenna A1 are integrated.

The second antenna A2 of the electromagnetic expansion and concentration module 4 is a magnetic dipole or a Hertzian dipole.

The third antenna A3 of the electromagnetic expansion and concentration module 4 is a first coil.

The fourth antenna A4 of the electromagnetic expansion and concentration module 4 is a second coil.

From the viewpoint of the planar arrangement, the Hertzian dipole A2 includes a first segment t1 and a second segment t2, on the whole having a length for example of λ/2 (λ wavelength; f=1/λ operative frequency of the far-field electromagnetic coupling of the second antenna A2).

The first segment t1 of the Hertzian dipole A2 has a first free end e1 and a second end e1′ electrically coupled to the second coil A4 at a first electric connection point c1.

The second segment t2 of the Hertzian dipole A2 has a first free end e2 and a second end e2′ electrically coupled to the second coil A4 at a second electric connection point c2.

The second coil A4, configured to communicate by a near-field magnetic coupling (the operative frequency of which depends on the length of the second coil A4) includes a first interruption defined by a first joining point r1 and a second joining point r2. The first joining point r1 and the second joining point r2 are substantially equidistant, from the first electric connection point c1 and from the second electric connection point c2, respectively, defined above.

The first coil A3, in turn configured to communicate by a near-field coupling (the operative frequency of which depends on the length of the first coil A3) includes a second interruption, having the same length of the first interruption present on the second coil A4, defined by a third joining point r3 and by a fourth joining point r4.

The first coil A3 and the second coil A4 are joined to one another so that the first joining point r1 coincides with the third joining point r3 and that the second joining point r2 coincides with the fourth joining point r4, defined above.

The second coil A4 has a length (and a circumscribed area) greater than the length (and a circumscribed area) of the first coil A3. This difference in the area allows the second coil A4 to transfer and to concentrate electromagnetic energy to the first coil A3.

The module to be monitored 2 (integrated chip including both the first antenna A1 and the integrated control circuitry 3) is arranged within the first coil A3.

FIG. 3 shows from a circuital viewpoint the electronic device for electromagnetic expansion and concentration 1 of the embodiment of FIG. 2.

As it can be noticed, the electromagnetic expansion and concentration electronic device 1 of the embodiment of the FIGS. 2 and 3 is in the broad band, since no resonance capacitors such as to impose a specific resonance frequency is present in the matching network (fourth antenna A4−third antenna A3).

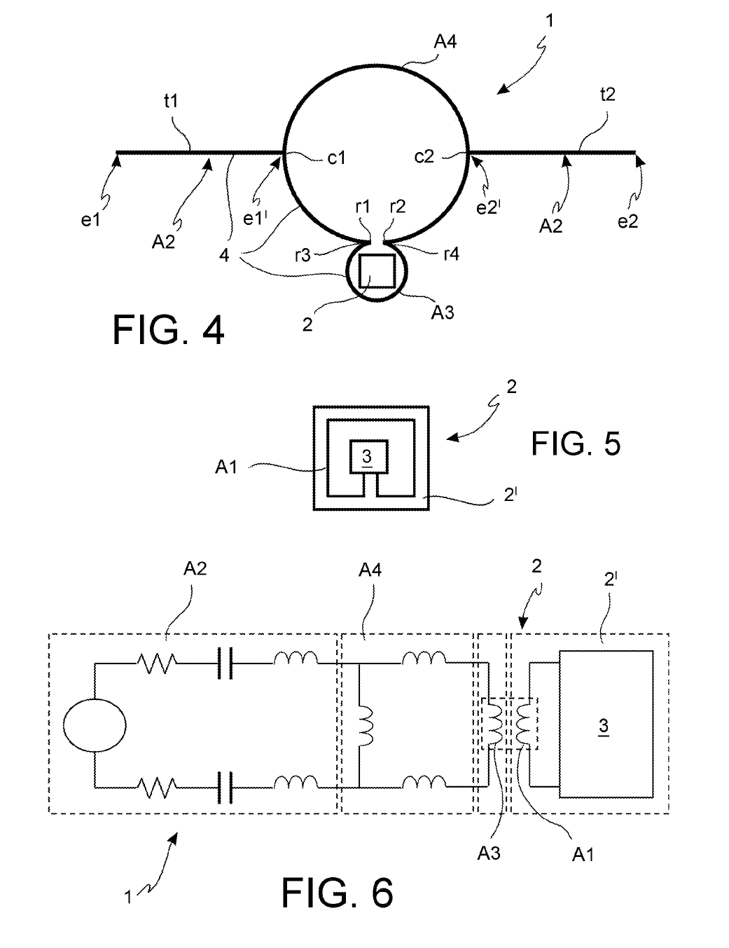

With reference to FIG. 4, an electronic device for electromagnetic expansion and concentration 1 according to a further embodiment is now described in a plane view.

In a manner completely similar to the embodiment of FIG. 2, in the electromagnetic expansion and concentration module 4, the second antenna A2 is a Hertzian dipole or a magnetic dipole, the third antenna A3 is a first coil, and the fourth antenna A4 is a second coil.

The arrangement and the type of electric connection or joint between the Hertzian dipole A2, the first coil A3, and the second coil A4 of the electromagnetic expansion and concentration module 4 of FIG. 4 are similar to those already described above for the electromagnetic expansion and concentration module 4 of the embodiment of FIG. 2; therefore they are not described again.

With reference to FIG. 5, it is pointed out that in this further embodiment, the first antenna A1 and the integrated control circuitry 3 are electrically coupled to one another within a package container 2′ or System in Package SiP.

FIG. 6 shows from a circuital viewpoint the electronic device for electromagnetic expansion and concentration 1 of the embodiment of FIGS. 4 and 5.

As it can be noticed, also in this case, the electromagnetic expansion and concentration electronic device 1 of the embodiment of FIGS. 4 and 5 is in the broad band, since resonance capacitors such as to impose a specific resonance frequency are not present in the matching network (fourth antenna A4−third antenna A3).

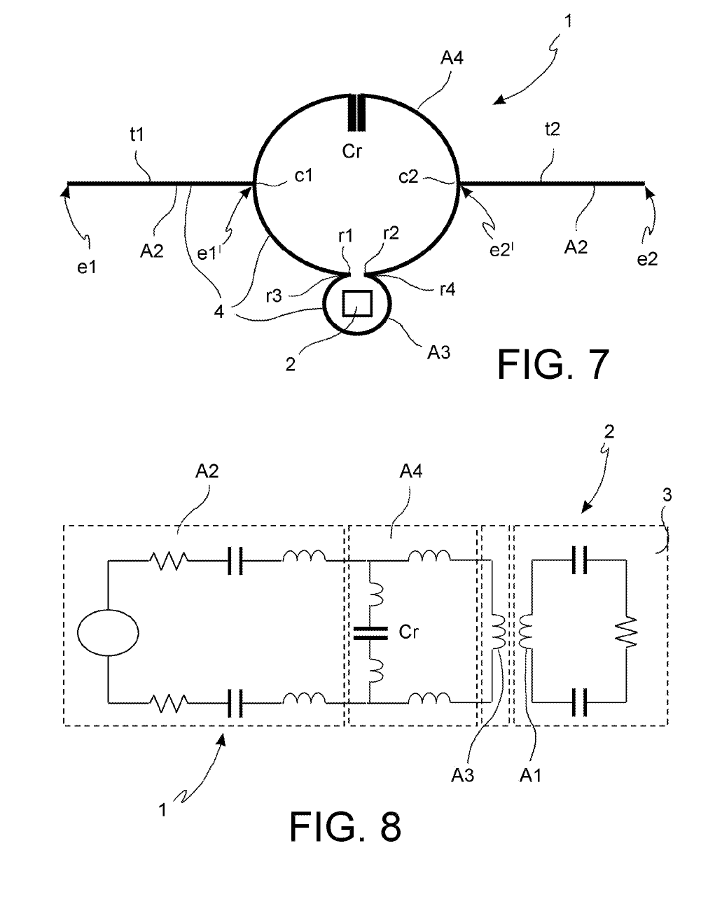

With reference to FIG. 7, an electronic device for electromagnetic expansion and concentration 1 according to a further embodiment is now described in a plane view.

In a manner completely similar to the embodiment of FIG. 2, in the electromagnetic expansion and concentration module 4, the second antenna A2 is a Hertzian dipole or a magnetic dipole, the third antenna A3 is a first coil, and the fourth antenna A4 is a second coil.

The arrangement and the type of electric connection or joint between the Hertzian dipole A2, the first coil A3, and the second coil A4 of the electromagnetic expansion and concentration module 4 of FIG. 4 are similar to those already described above for the electromagnetic expansion and concentration module 4 of the embodiment of FIG. 2; therefore they are not described again.

As illustrated in FIG. 7, the fourth antenna A4, in addition to the second coil, further includes a resonant capacitor Cr. The resonant capacitor Cr is arranged in a position diametrically opposite to that of the joining points of the second coil A4 with the first coil A3. Furthermore, the resonant capacitor Cr is located substantially equidistant from the first electric connection point c1 and from the second connection point c2.

It is pointed out that the first antenna A1 and the integrated control circuitry 3 can be integrated in the same chip, or the first antenna A1 can be separated from the integrated chip corresponding to the integrated control circuitry 3, while being both housed within a package or SiP.

FIG. 8 shows from a circuital viewpoint the electronic device for electromagnetic expansion and concentration 1 of the embodiment of FIG. 7.

As it can be noticed, the electromagnetic expansion and concentration electronic device 1 of the embodiment of FIG. 7, in consideration of the presence of the resonant capacitor Cr within the matching network A4, is in the narrow band, both in a far-field electromagnetic coupling (second antenna A2) and in a near-field magnetic coupling (fourth antenna A4), i.e., it is a device resonating at the resonance frequency due to the resonant capacitor Cr.

It shall be noticed that the electromagnetic expansion and concentration electronic device 1 of the embodiment of FIG. 7 allows transferring energy to the module to be monitored 2 better than the previously described embodiments, since the system 100 is configured to resonate at the operative frequency of interest.

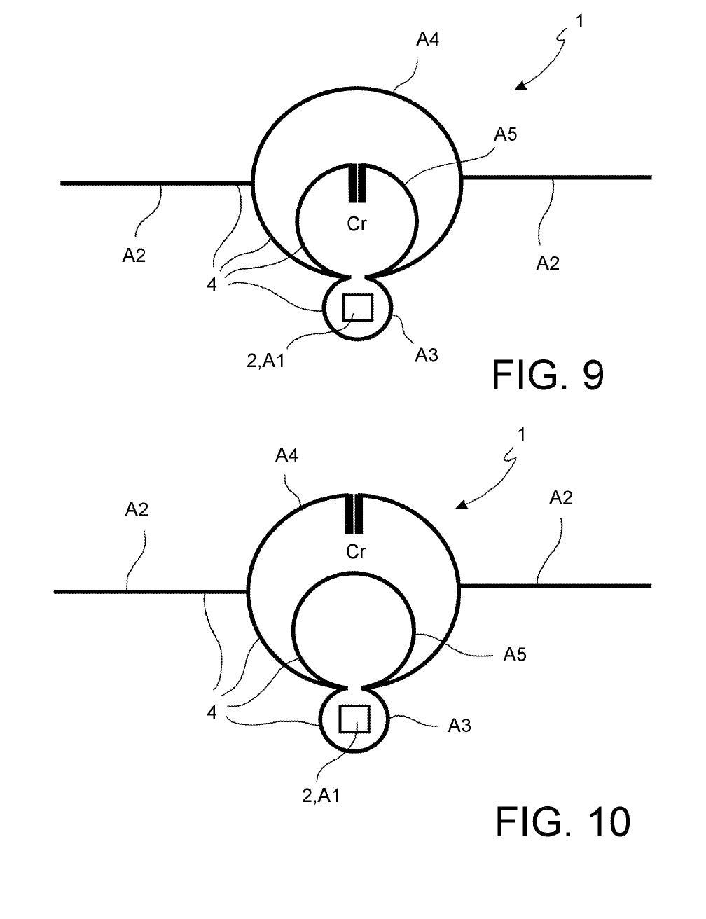

In accordance with the different embodiments illustrated and described in the FIGS. 9-12, it is pointed out that, generally, the electromagnetic expansion and concentration module 4 of the electromagnetic expansion and concentration electronic device 1 further includes a fifth antenna A5 electrically coupled between the second antenna A2 and the third antenna A3. The fifth antenna A5 is configured to communicate with a further remote antenna (not shown in the Figures) of a further external data collection and control device (not illustrated either in the Figures) by a near-field magnetic coupling.

Referring now to FIG. 9, in a manner completely similar to the embodiment of FIG. 2, in the electromagnetic expansion and concentration module 4, the second antenna A2 is a Hertzian dipole or a magnetic dipole, the fourth antenna A4 is a second coil, the third antenna A3 is a first coil, and the fifth antenna A5 is a third coil.

The arrangement and the type of electric connection or joint between the Hertzian dipole A2, the second coil A4 and the first coil A3 of the electromagnetic expansion and concentration module 4 of FIG. 4 are similar to those already described above for the electromagnetic expansion and concentration module 4 of the embodiment of FIG. 2; therefore they are not described again.

The third coil A5 is arranged within the second coil A4. The third coil A5, in turn configured to communicate by a near-field coupling (the operative frequency of which depends on the length of the third coil A5) includes a third interruption, having the same length of the first interruption present on the second coil A4, defined by a fifth joining point r5 and a sixth joining point r6.

The first coil A3, the second coil A4, and the third coil A5 are joined to one another so that the first joining point r1, the third joining point r3, and the fifth joining point r5 coincide with each other and the second joining point r2, the fourth joining point r4, and the sixth joining point r6 coincide with each other.

As illustrated in FIG. 9, the fifth antenna A5, in addition to the third coil, further includes a resonant capacitor Cr. The resonant capacitor Cr is arranged in a position diametrically opposite to that of the joining points of the first coil A4 (or of the second coil A3) with the third coil A5.

Again, it is pointed out that the first antenna A1 and the integrated control circuitry 3 can be integrated in the same chip, or the first antenna A1 can be separated from the integrated chip corresponding to the integrated control circuitry 3, while being both housed within a package or SiP.

The electromagnetic expansion and concentration electronic device 1 of the embodiment of FIG. 9 is in the broadband both in the far-field electromagnetic coupling (second antenna A2) and in near-field magnetic coupling (fourth antenna A4), since no resonance capacitor is present in the fourth antenna (second coil A4). Furthermore, the electromagnetic expansion and concentration electronic device 1 of the embodiment of FIG. 9 is in the narrow band in the near-field magnetic coupling (fifth antenna A5−third coil A5 with resonance capacitor Cr) i.e., is a device resonating at the resonance frequency due to the resonant capacitor Cr.

It shall be noticed that both the fourth antenna A4 and the fifth antenna A5 can perform the function of a matching network for the second antenna A2 for the module to be monitored 2.

Furthermore, it is pointed out that, in addition to the fourth antenna A4 and the fifth antenna A5, the expansion and concentration module may include a further matching network (not shown in the Figures) electrically coupled, for example, between the second antenna A2 and the third antenna A3, between the fourth antenna A4 and the third antenna A3, or between the fifth antenna A5 and the third antenna A3.

With reference to the embodiment of FIG. 10, the second antenna A2 is a Hertzian dipole or a magnetic dipole, the third antenna A3 is a first coil, the fourth antenna A4 is a second coil, and the fifth antenna A5 is a third coil.

The arrangement and the type of electric connection or joint between the Hertzian dipole A2, the first coil A3, the second coil A4, and the third coil A5 of the electromagnetic expansion and concentration module 4 of FIG. 10 are similar to those already described above for the electromagnetic expansion and concentration module 4 of the embodiment of FIG. 9; therefore they are not described again.

As illustrated in FIG. 10, the second coil A4 includes a resonance capacitor Cr (as in FIG. 7), while the third coil A5 does not include any resonance capacitor.

Again, it is pointed out that the first antenna A1 and the integrated control circuitry 3 can be integrated in the same chip, or the first antenna A1 can be separated from the integrated chip corresponding to the integrated control circuitry 3, while being both housed within a package or SiP.

The electronic device for electromagnetic expansion and concentration 1 of the embodiment of FIG. 10 is in the narrow band both in the far-field electromagnetic coupling (second antenna A2) and in the near-field magnetic coupling (fourth antenna A4), since the resonance capacitor Cr is present in the fourth antenna (first coil A4). Furthermore, the electronic device for electromagnetic expansion and concentration 1 of the embodiment of FIG. 10 is the broad band in the near-field magnetic coupling (fifth antenna A5−third coil A5), since no resonance capacitor is present in the third coil A5.

Also in this case, both the fourth antenna A4 and the fifth antenna A5 can perform the function of a matching network for the second antenna A2 for the module to be monitored 2.

Furthermore, it is pointed out that, in addition to the fourth antenna A4 and the fifth antenna A5, the expansion and concentration module may include a further matching network (not shown in the Figures) electrically coupled, for example, between the second antenna A2 and the third antenna A3, between the fourth antenna A4 and the third antenna A3, or between the fifth antenna A5 and the third antenna A3.

With reference to the embodiment of FIG. 12, the second antenna A2 is a Hertzian dipole or a magnetic dipole, the third antenna A3 is a first coil, the fourth antenna A4 is a second coil, and the fifth antenna A5 is a third coil.

The arrangement and the type of electric connection or joint between the Hertzian dipole A2, the first coil A3, the second coil A4, and the third coil A5 of the electromagnetic expansion and concentration module 4 of FIG. 12 are similar to those already described above for the electromagnetic expansion and concentration module 4 of the embodiment of FIG. 9; therefore, they are not described again.

As illustrated in FIG. 12, the second coil A4 includes a resonance capacitor Cr (as in FIG. 10). The third coil A5 includes a further resonance capacitor Cr′ (as in FIG. 9).

Again, it is pointed out that the first antenna A1 and the integrated control circuitry 3 can be integrated in the same chip, or the first antenna A1 can be separated from the integrated chip corresponding to the integrated control circuitry 3, while being both housed within a package or SiP.

The electromagnetic expansion and concentration electronic device 1 of the embodiment of FIG. 12 is in the narrow band both in the far-field electromagnetic coupling (second antenna A2) and in the near-field magnetic coupling (fourth antenna A4). In more detail, the device has two different resonance frequencies for the near-field magnetic coupling, one corresponding to the resonance capacitor Cr present in the second coil A4 (fourth antenna A4) and one corresponding to the further resonance capacitor Cr′ present in the third coil A5 (fifth antenna A5), and a single resonance frequency for the far-field electromagnetic coupling, i.e., the one corresponding to the resonance capacitor Cr present in the second coil A4 (fourth antenna A4).

Also in this case, both the fourth antenna A4 and the fifth antenna A5 can perform the function of a matching network for the second antenna A2 for the module to be monitored 2. Furthermore, in addition to the fourth antenna A4 and the fifth antenna A5, the electromagnetic expansion and concentration module may include a further matching network (not shown in the Figures) electrically coupled, for example, between the second antenna A2 and the third antenna A3, between the fourth antenna A4 and the third antenna A3, or between the fifth antenna A5 and the third antenna A3.

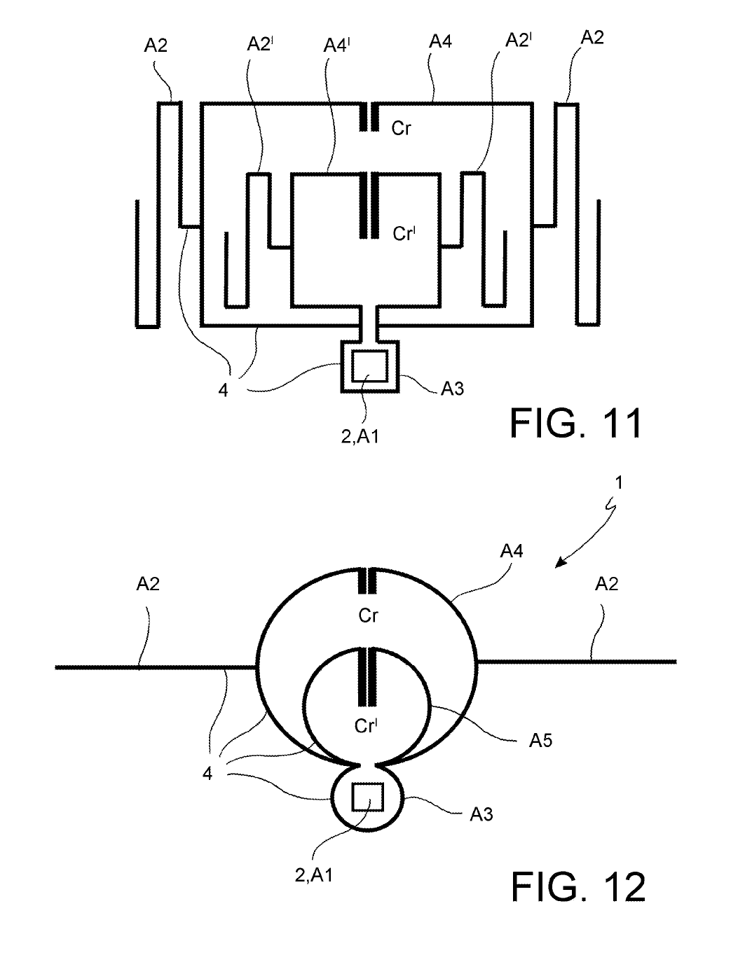

Referring now to the embodiment of FIG. 11, the electronic device for electromagnetic expansion and concentration 1 includes an electromagnetic expansion and concentration module 4 completely similar to the one described with reference to the embodiment of FIG. 7.

Furthermore, the expansion and concentration module of FIG. 11 includes a further second antenna A2′ (Hertzian dipole or magnetic dipole) and a further fourth antenna A4′ (further coil) arranged within the second coil A4 (fourth antenna A4). The further second antenna A2′ is electrically coupled to the third antenna A3 through the further fourth antenna A4′. The further coil corresponding to the further fourth antenna A4′ includes a further resonance capacitor Cr′.

The electronic device for electromagnetic expansion and concentration 1 of the embodiment of FIG. 11 is a so-called double or dual band device. In fact, such device is in the narrow band both in the far-field electromagnetic coupling and in the near-field magnetic coupling, with two different resonance frequencies, one corresponding to the resonance capacitor Cr present in the second coil A4 (fourth antenna A4) and one corresponding to the further resonance capacitor Cr′ present in the further coil A4′ (further fourth antenna A4′).

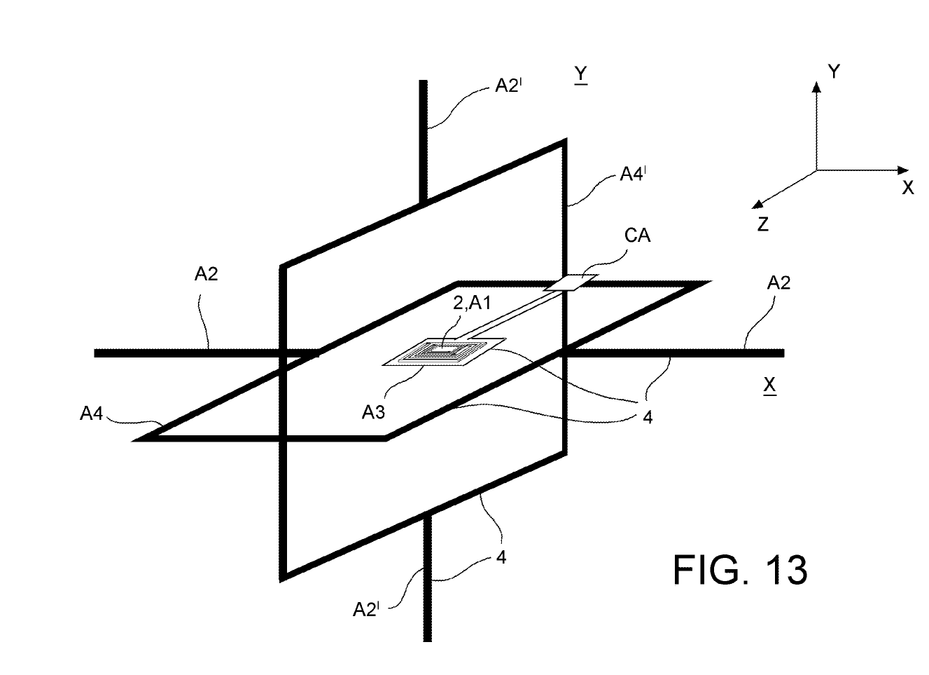

Referring now to FIG. 13, the electromagnetic expansion and concentration electronic device 1 may include an electric expansion and concentration module 4 and a module to be monitored 2 arranged on a first reference plane X (for example, a horizontal plane). The expansion and concentration module 4 can be similar to that described above with reference to the embodiment of FIG. 2.

The electromagnetic expansion and concentration module 4 may further include a further second antenna A2′ (further Hertzian dipole or magnetic dipole) and a further fourth antenna A4′ (further coil) electrically coupled to one another and arranged on a second reference plane Y (for example the vertical plane), orthogonal to the first reference plane X.

The further fourth antenna A4′ is electrically coupled to the third antenna A3, arranged on the first reference plane X, through an electric circuit CA (for example a capacitor or a matching network).

The structure illustrated in FIG. 13 can be included within a single package or container.

Therefore, the electronic device for electromagnetic expansion and concentration 1 of FIG. 13 includes a horizontal polarization antenna A2, A4 and a polarization antenna A2′, A4′ allowing the electronic device for electromagnetic expansion and concentration 1 to increase its efficiency, since it can communicate data in at least two directions (the horizontal one and the vertical one).

In accordance with a further variant, the electromagnetic expansion and concentration module 4 may further include further Hertzian dipole portions (not shown in the Figure) electrically coupled to each of said fourth antenna A4 and further fourth antenna A4′, optionally arranged with an inclination by an angle of 45° relative to the first horizontal reference horizontal plane X or the second reference plane Y.

In this manner, it is possible to make even more omnidirectional the electronic device for electromagnetic expansion and concentration 1.

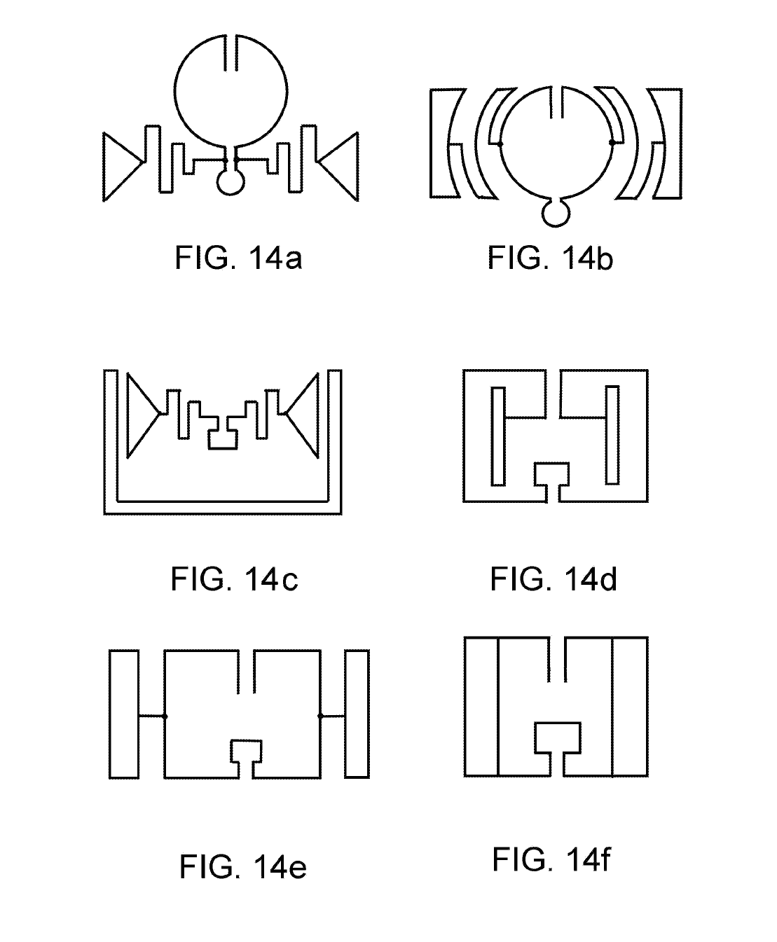

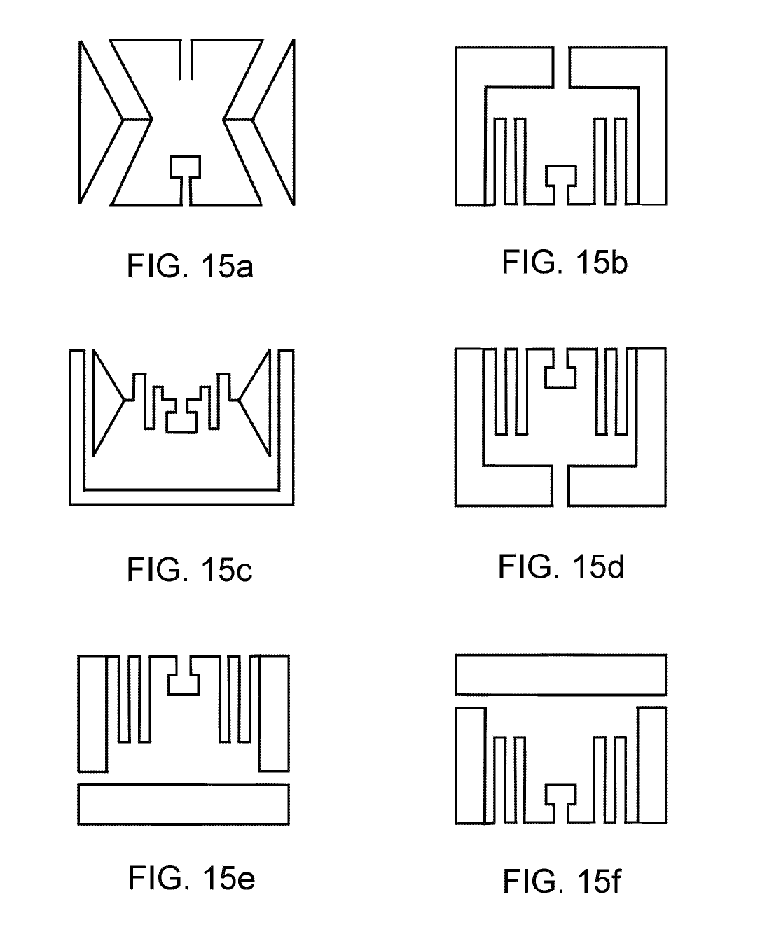

FIGS. 14a-14f and FIGS. 15a-15f illustrate different embodiments of the electronic device for electromagnetic expansion and concentration 1, in which the different functionalities of a far-field electromagnetic coupling and a near-field magnetic coupling can be combined together, in the broad band or in the narrow band, whether in the narrow band it may have one or more resonance frequencies, and so on.

As it can be seen, an embodiment of the electronic device for electromagnetic expansion and concentration described has several advantages.

First of all, providing a matching network (fourth antenna A4) between the second antenna A2 and the module to be monitored 2 allows increasing the stability and reliability of the device.

Furthermore, the fact that the fourth antenna A4 is configured to communicate in the near-field magnetic coupling while the second antenna is configured to communicate in the far-field electromagnetic coupling, allows the electronic device for electromagnetic expansion and concentration 1 being more redundant, hence adaptable compared to conventional devices.

Finally, the fact that the module to be monitored 2 is galvanically isolated from the electromagnetic expansion and concentration module, i.e., it is free from electric and physical connections towards the third antenna A3, allows a quicker and more reliable assembling of the device, since the module to be monitored 2 has to be aligned with the third antenna A3 with less stringent requirements both in precision and in repeatability and reproducibility, thus providing for reduced manufacturing costs and times.

To the embodiments of the device described above, in order to meet contingent needs, one will be able to make modifications, adaptations, and replacements of elements with functional equivalents, without departing from the spirit and scope of the disclosure. Furthermore, each of the characteristics described as belonging to a possible embodiment can be obtained independently from the other embodiments described. For example, the integrated control circuitry 3 may include a computing circuit such as a microprocessor or a microcontroller. Furthermore, a system may include more than one device 1, and a device 1 may include more than one module 2.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1-15. (canceled)

16. An apparatus, comprising:
a module including
a circuit, and
a first antenna coupled to the circuit; and
an interface including
a second antenna disposed adjacent to the first antenna,
a third antenna coupled to the second antenna, and
a fourth antenna coupled to the third antenna.

17. The apparatus of claim 16 wherein the second antenna is disposed around the first antenna.

18. The apparatus of claim 16 wherein the third antenna is galvanically coupled to the second antenna.

19. The apparatus of claim 16 wherein the fourth antenna includes:
a first segment galvanically coupled to a first node of the third antenna; and
a second segment galvanically coupled to a second node of the third antenna

20. The apparatus of claim 16 wherein:
the second antenna is approximately circular and has a first diameter; and
the third antenna is approximately circular and has a second diameter that is larger than the first diameter.

21. The apparatus of claim 16 wherein:
the second antenna is approximately circular and has a first end and a second end spaced from the first end; and
the third antenna is approximately circular and has a first end coupled to the first end of the second antenna and has a second end coupled to the second end of the second antenna.

22. The apparatus of claim 16 wherein the third antenna includes a gap.

23. The apparatus of claim 16 wherein the second antenna is disposed within a region defined by the third antenna.

24. The apparatus of claim 16 wherein the second antenna is disposed outside of a region defined by the third antenna.

25. The apparatus of claim 16 wherein the interface includes a fifth antenna coupled to the second and third antennas.

26. The apparatus of claim 16 wherein the interface includes a fifth antenna coupled to the second and third antennas and including a gap.

27. The apparatus of claim 16 wherein:
the third antenna has an orientation relative to the second antenna; and
the interface includes a fifth antenna coupled to the second and third antennas and having another orientation relative to the second antenna.

28. The apparatus of claim 16 wherein:
the second antenna has a first impedance;
the fourth antenna has a second impedance; and
the third antenna is configured to couple the second antenna and the third antenna by presenting to the second antenna a third impedance that is approximately equal to the first impedance and by presenting to the fourth antenna a fourth impedance that is approximately equal to the second impedance.

29. A system, comprising:
a first unit including
a module including
a circuit, and
a first antenna coupled to the circuit; and
an interface including
a second antenna disposed adjacent to the first antenna,
a third antenna coupled to the second antenna, and
a fourth antenna coupled to the third antenna; and
a second unit configured to communicate with one of the third and fourth antennas.

30. The system of claim 29 wherein the second unit is configured to communicate with the one of the third and fourth antennas by far-field electromagnetic coupling.

31. The system of claim 29 wherein the second unit is configured to communicate with the one of the third and fourth antennas by near-field magnetic coupling

32. A method, comprising:
allowing a first signal to propagate between a first antenna and a second antenna via a third antenna, the first antenna having a first impedance and the second antenna having a second impedance;
presenting to the first antenna with the third antenna approximately the first impedance; and
presenting to the second antenna with the third antenna approximately the second impedance.

33. The method of claim 32, further comprising allowing the first signal to propagate between one of the first and second antennas and a fourth antenna via near-field magnetic coupling.

34. The method of claim 32, further comprising allowing the signal to propagate between one of the first and second antennas and a fourth antenna via far-field electromagnetic coupling.

35. The method of claim 32, further comprising:
receiving a second signal with the third antenna via near-field magnetic coupling;
coupling the second signal from the third antenna to one of the first and second antennas;
transmitting the second signal from the one of the first and second antennas to a fourth antenna via near-field magnetic coupling;
powering a circuit with the second signal received with the fourth antenna.
